(19) United States
(12) Patent Application Publication
(10) Pub. No.: US 2025/0163318 A1
(43) Pub. Date: May 22, 2025

(54) FUNCTIONALIZED CARBON NANOTUBE COMPOSITE BIOMATERIALS AND METHODS THEREOF

(71) Applicant: University of Maryland, College Park, College Park, MD (US)

(72) Inventors: YuHuang WANG, Laurel, MD (US); Abhindev Kizhakke VEETIL, College Park, MD (US)

(21) Appl. No.: 18/954,242

(22) Filed: Nov. 20, 2024

Related U.S. Application Data
(60) Provisional application No. 63/601,071, filed on Nov. 20, 2023.

(51) Int. Cl. C09K 11/06; C01B 32/159; C01B 32/174

(52) U.S. Cl. CPC C09K 11/06; C01B 32/159; C01B 32/174; C01B 2202/02; C09K 2211/10

(57) ABSTRACT

This present disclosure is directed to functionalized carbon nanotube composite biomaterials and methods of making the same. The composite biomaterials comprise sp³ defects, or organic color centers, which allow for shortwave infrared emissions.

### CROSS REFERENCE TO RELATED APPLICATIONS

This application claims priority to U.S. Application No. 63/601,071, filed on Nov. 20, 2023, the contents of which are hereby incorporated by reference in its entirety.

### FIELD OF THE INVENTION

The field of the invention relates generally to carbon nanotubes and biomaterials. More specifically, the present disclosure relates to functionalized carbon nanotube composite biomaterials and methods of preparation thereof.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

DNA, or deoxyribonucleic acid, is a fundamental molecule that encapsulates the genetic blueprint guiding the growth, development, functioning, and reproduction of all known living organisms, including many viruses. DNA comprises simpler units known as nucleotides, each comprising a sugar component (deoxyribose), a phosphate group, and a nitrogenous base. There are four types of nitrogenous bases in DNA: adenine (A), cytosine (C), guanine (G), and thymine (T).

DNA represents just one category within the broader family of biopolymers. This group includes various other molecules such as RNA (ribonucleic acid), which plays a central role in genetic expression and regulation; proteins, which perform a myriad of functions including catalysis and structural support; polysaccharides like cellulose, chitin, and starch, which serve as structural elements and energy reserves; and lipids, which are components of cellular membranes and also act as long-term energy storage.

Semiconducting single-wall carbon nanotubes (SWCNTs) are nanostructures of carbon atoms arranged in a single-layered cylindrical pattern. They possess optical properties such as photoluminescence, which allows them to absorb and re-emit light at specific near-infrared wavelengths. Their distinct absorption spectra feature peaks corresponding to different electronic transitions (e.g., E11, E22), which vary based on the nanotube's diameter and chirality. These characteristics make them valuable for exemplary applications like biological imaging, where their fluorescent properties can be utilized.

In terms of electronic properties, semiconducting SWCNTs have a bandgap, which enables them to switch between conductive and insulative states. Their charge carriers, notably high-mobility electrons and holes, support rapid electrical conduction, ideal for high-performance electronic devices such as transistors. Additionally, the electronic behavior of these nanotubes can be finely tuned through chemical doping or external electric fields, paving the way for versatile applications in electronics and sensor technology. Quantum confinement effects within SWCNTs further contribute to their unique properties, resulting in quantized energy levels that influence optical and electronic functions.

Organic color centers (OCCs) are sp³ quantum defects that can be synthesized in pristine carbon nanotube semiconductor crystals using organic chemistry techniques. They are formed by sp³-hybridized atomic defects in the sp² carbon lattice of the nanotubes. These defects act as exciton traps, optically allowed to emit photoluminescence in the short-wave infrared range (900-1700 nm). The emission from OCCs is bright and can be tuned at the molecular level; it is also of a single-photon nature, making OCCs promising for efficient quantum interfaces.

Single-stranded DNA can encapsulate SWCNTs through 7-71 stacking interactions, forming stable hybrids where the DNA sequence can influence redox reactions and control various physicochemical properties of the SWCNTs, including hydrophobicity and chemical reactivity. Furthermore, OCCs can boost the quantum yield of SWCNT fluorescence significantly and confer new chemical sensitivities based on the nature of the defect. These OCC-induced fluorescence peaks are highly sensitive to the local microenvironment. They can be manipulated systematically through functional group modifications, providing a pathway for creating a diverse range of biochemical probes.

Prior work in the field of SWCNT functionalization has used DNA to program the positioning of defects on SWCNTs. Weisman, Zheng, and others have used singlet oxygen to bind guanine nucleobases covalently to nanotubes, creating what are known as sp² defect pairs.

However, the sp² defects, while representing a novel approach to functionalizing SWCNTs, have limitations in their application. These sp² defects are characterized as shallow exciton traps with dim photoluminescence and broad spectral emission that often spectrally overlap undesirably with the E11 of the native nanotube. Such characteristics pose challenges for their use in quantum, biosensing, and imaging applications, which demand distinct and sharp spectral features for precision sensing and information processing. Covalently linking DNA through a linking molecule is a technique which has been used to attach DNA to the surface of carbon nanotubes. In these methods, however, DNA is not directly coupled to nanotubes and requires a pre-installed linker on the nanotube surface. A similar approach has been used for peptides and proteins. In another method, UV light is utilized for the activated reaction of aromatic iodide with carbon nanotube. This approach requires the incorporation of photosensitive moieties such as an iodine modified base in the DNA sequence to activate the reaction.

The utilization of pristine biopolymers, such as DNA, instead of biopolymer which require prior incorporation of modified bases may lead to making the synthesis process cost effective and lead to the generation of new OCC-DNA hybrids that comprise distinct composite matters.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1. FIG. 1 displays a schematic showing exemplary single walled carbon nanotubes wrapped with DNA sequence 5′-TGTGTGTGTGTGT-3′.

FIGS. 2A-2C. FIG. 2 displays optical characterization of the reaction. FIG. 2A displays absorption spectra of DNA-SG65i dispersion in 0.1 M NaCl and 2 mM Na2CO3 in D₂O before (black trace) and after (red trace) 1.5 hours of 254 nm UV irradiation. FIG. 2B displays emission spectra before (black trace) and after (red trace) 254 nm UV irradiation. Note that the intensity is normalized at the emission maximum. Post-irradiation effects include a 5 nm red shift in the E11 maximum and the emergence of a new peak at 1273 nm. FIG. 2C displays absolute emission intensities before (black trace) and after (red trace) UV exposure. Emission is attenuated by a factor of 2 following irradiation. All photoluminescence (PL) spectra were obtained with an excitation wavelength of 565 nm.

FIGS. 3A-3C. FIG. 3 displays kinetic analysis of the UV-induced reaction. FIG. 3A displays time-resolved absorption spectra of DNA-SG65i dispersion in 0.1 M NaCl and 2 mM Na2CO3 in D₂O, recorded at 30-minute intervals during 254 nm UV irradiation. The decreasing intensity at the 994 nm E11 absorption band of the (6,5)-SWCNTs indicates the reaction's progression. FIG. 3B displays a detailed absorption profile from 200 nm to 300 nm of the samples described in FIG. 3A, showing a decrease in DNA absorbance at 260 nm over time, which suggests ongoing DNA modification. FIG. 3C displays absorption spectra normalized at the E11 maximum for samples irradiated from 0 to 1.5 hours, highlighting a 7 nm red shift in the E11 peak.

FIGS. 4A-4B. FIG. 4 displays absorption changes during reaction. FIG. 4A displays a time-dependent decrease in absorbance at 994 nm (initial E11 maximum of the (6,5) species in the reaction mixture) plotted over time. Linear regression of the data points yields a slope of −0.022 hour⁻¹, indicating reduced SWCNT absorbance due to interaction with DNA. FIG. 4B displays a decline in absorption at 260 nm, representative of DNA absorbance, as the reaction proceeds. A linear fit to these data points gives a slope of −0.047 hour⁻¹, signifying the consumption of DNA as the reaction proceeds.

FIGS. 5A-5B. FIG. 5 displays kinetics of the UV-induced reaction. FIG. 5A displays a time-dependent decline in the carbon concentration at 994 nm (initial E11 peak of (6,5) SWCNT in the reaction mixture) over time. A linear regression analysis of the data reveals a decrease with a rate of −4.4×10⁻⁶ M⁻¹hour⁻¹, reflecting the consumption of SWCNTs as they interact with DNA. FIG. 5B displays a reduction in DNA concentration at 260 nm, indicative of DNA absorbance, over the course of the reaction. Linear fitting of these data yields a rate of −3.8×10⁻⁷ M⁻¹hour⁻¹. The concentration of (6,5) carbon is derived using an extinction coefficient of 4400 M⁻¹cm⁻¹, demonstrating that carbons react at an order of magnitude faster than DNA.

FIGS. 6A-6C. FIG. 6 displays optical characterization of the reaction under nitrogen purging. FIG. 6A displays absorption spectra of the DNA-SG65i dispersion in 0.1 M NaCl and 2 mM Na₂CO₃ in D₂O before (black trace) and after (red trace) 20 minutes of 254 nm UV irradiation under N₂. FIG. 6B displays normalized emission spectra at the emission maximum before (black trace) and after (red trace) 254 nm UV irradiation, revealing the development of two new peaks at 1117 nm and 1239 nm. FIG. 6C displays a comparison of absolute emission intensities of the reaction mixture before (black trace) and after (red trace) UV exposure, showing a 15-fold decrease in emission intensity post-irradiation.

FIGS. 7A-7C. FIG. 7 displays kinetic analysis of the UV-induced reaction with N₂ purging. FIG. 7A displays sequential absorption spectra of the DNA-SG65i dispersion in 0.1 M NaCl and 2 mM Na₂CO₃ in D₂O, recorded every 1.5 minutes during exposure to 254 nm UV light with N₂ purging. A diminishing E11 peak at 994 nm for the (6,5)-SWCNT signifies ongoing reaction progression. FIG. 7B displays detailed absorption from 200 nm to 300 nm for the samples in FIG. 7A, with a noted decrease in DNA-specific absorbance at 260 nm, indicating DNA involvement in the covalent bonding. FIG. 7C displays normalized absorption spectra at the E11 maximum, displaying a 6 nm blue shift at the 7.5-minute mark, suggestive of changes in the electronic environment of the SWCNTs.

FIGS. 8A-8B. FIG. 8 displays absorption changes. FIG. 8A displays temporal change in absorbance at 994 nm (E11 maximum of the (6,5) nanotubes in the reaction mixture at t=0 hour) plotted over time. Data points were modeled with a sigmoidal fit, revealing a maximum rate of change (derivative max) at 3.75 minutes. This indicates a reduction in SWCNT absorbance as the reaction with DNA proceeds. FIG. 8B displays a graph monitoring the decrease in absorbance at 260 nm, indicative of DNA, throughout the reaction. Sigmoidal fitting of these data points shows a derivative max at 3.37 minutes, suggesting a rapid engagement of DNA in the reaction after initial lag phases.

FIGS. 9A-9B. FIG. 9 displays analysis of the reaction kinetics based on concentration changes. FIG. 8A displays the change in the concentration of the (6,5)-SWCNT at 994 nm (E11 maximum) from the start of the reaction is tracked over time. A linear regression applied to the initial phase before the plateau provides a slope of −2.5×10⁻⁶ M min⁻¹, indicative of the decrease in SWCNT concentration as the reaction with DNA occurs. FIG. 9B displays the concentration decrease in DNA at 260 nm—characteristic of DNA absorbance—is also plotted over time, with a linear fit to the pre-plateau data yielding a slope of −3.8×10⁻⁷ M min⁻¹. These observations suggest that the (6,5)-SWCNTs react at a rate an order of magnitude faster than the DNA, calculated with the nanotubes' extinction coefficient of 4400 M⁻¹ cm⁻¹.

FIG. 10. FIG. 10 displays a schematic representation of an exemplary method for creating OCCs. Step 1. Wrapping SWCNT with DNA by tip sonication. Step 2. In situ diazotization of DNA bases with sodium nitrite and HCl. Step 3. The reactive species (diazonium) formed in step 2 covalently bonds with carbon nanotube forming OCCs.

FIGS. 11A-11C. FIG. 11 displays spectral evidence for the creation of organic color center (OCCs) in DNA-wrapped singled-walled carbon nanotubes (SWCNTs). FIG. 11A displays emission spectra of 5′-(GT)₁₅-3′ wrapped SWCNTs before (black trace) and after (red trace) the reaction. The photoluminescence spectrum was obtained by averaging the emission spectra of individual SWCNTs excited with a 730 nm laser and recorded using a hyperspectral imager. A new emission peak appears at 1140 nm, corresponding to a 170 meV red-shift from the pristine peak, indicating the formation of covalent bonds between the DNA and the nanotubes. FIG. 11B displays emission spectra of 5′-TTATATTATTATT-3′ wrapped (6,5) SWCNTs (purified by DNA-based aqueous two-phase extraction) before (black trace) and after (red trace) the reaction. The photoluminescence spectrum was obtained by averaging the emission spectra of individual SWCNTs excited with a 560 nm laser and captured using a hyperspectral imager. A new emission peak appears at 1130 nm, corresponding to a 150 meV red-shift from the original peak, further confirming the covalent bond formation between the DNA and the SWCNTs. FIG. 11C displays emission spectra of 5′-T₁₄CT₁₅-3′ wrapped SG65i SWCNTs before (black trace) and after (red trace) the reaction. The photoluminescence spectrum was measured in solution by exciting the SWCNTs with 565 nm light using a Nanolog fluorescence spectrometer. The reaction results in the formation of a new emission peak at 1146 nm, corresponding to a 180 meV red-shift from the pristine peak, providing additional evidence of the successful covalent bonding between the DNA strands and the carbon nanotubes.

FIGS. 12A-12C. FIG. 12 displays Raman-scattering characterization of organic color centers (OCCs) in DNA-wrapped single-walled carbon nanotubes (SWCNTs). FIG. 12A displays Raman spectra of (GT)₁₅-wrapped SWCNTs before (black trace) and after (red trace) the reaction, collected by exciting with a 532 nm laser. Samples were drop-cast on a gold substrate to facilitate Raman measurements. Defect formation is evidenced by an increase in the D/G ratio from 0.017 to 0.042 after the reaction. FIG. 11B displays Raman spectra of 5′-TTATATTATTATT-3′ wrapped (6,5) SWCNTs before (black trace) and after (red trace) the reaction, collected by exciting with a 532 nm laser. Defect formation is indicated by an increase in the D/G ratio from 0.02 to 0.07 after the reaction. FIG. 11C displays Raman spectra of 5′-T₁₄CT₁₅-3′ wrapped SWCNTs before (black trace) and after (red trace) the reaction, collected by exciting with a 532 nm laser. Defect formation is demonstrated by an increase in the D/G ratio from 0.02 to 0.05 after the reaction.

FIGS. 13A-13C. FIG. 13 displays absorption spectroscopy monitoring defect formation in DNA-wrapped single-walled carbon nanotubes (SWCNTs). FIG. 13A displays absorption spectra of 5′-(GT)₁₅-3′ wrapped SWCNTs before (black trace) and after (green trace) the reaction. A decrease in absorption at 990 nm (E₁₁ of (6,5) SWCNT), along with the defect peak observed in FIG. 11A, suggests OCC formation. FIG. 13B displays absorption spectra of 5′-TTATATTATTATT-3′ wrapped (6,5) SWCNTs (purified by DNA-based aqueous two-phase extraction) before (black trace) and after (red trace) the reaction. A decrease in absorption at 990 nm (E₁₁ of (6,5) SWCNT), along with the defect peak observed in FIG. 11B, suggests OCC formation. FIG. 13C displays absorption spectra of 5′-T₁₄CT₁₅-3′ wrapped SG65i SWCNTs before (black trace) and after (red trace) the reaction. A decrease in absorption at 990 nm (E₁₁ of (6,5) SWCNT), along with the defect peak observed in FIG. 11C, suggests OCC formation.

FIGS. 14A-14B. FIG. 14 displays graphs showing that thymine does not possess an amine group for diazotization in DNA-wrapped single-walled carbon nanotubes (SWCNTs). FIG. 14A displays absorption spectra of 5′-(T)₃₀-3′ wrapped SWCNTs before (black trace) and after (blue trace) the reaction. The red trace represents the reaction mixture without sodium nitrite to explore the effect of pH on the system. Although there is a decrease in absorption at 990 nm (E11 of (6,5) SWCNT) under reaction conditions for diazotization, the characteristic defect peak observed in photoluminescence spectra is not seen. FIG. 14B displays photoluminescence spectra of 5′-(T)₃₀-3′ wrapped SWCNTs before (black trace) and after (blue trace) the reaction, collected by exciting with a 563 nm laser. The absence of the characteristic defect peak supports our claim that the reaction proceeds through a diazonium-mediated pathway.

FIGS. 15A-15C. FIG. 15 displays a schematic representation of DNA OCCs. FIG. 15A displays an exemplary drawing of a DNA-wrapped single-walled carbon nanotube. DNA comprises a phosphate backbone, deoxyribose sugar, and nucleotide bases. Adenine guanine and cytosine possess an amine group, which is a precursor for the diazonium reaction. FIG. 15B displays a drawing showing an example of organic color centers created by covalently bonding nucleotide bases with SWCNT. The carbon in the base, which was bonded to the amine group, covalently bonds with the carbon of SWCNT, resulting in sp³ hybridization for carbons participating in bonding. Thymine did not form OCCs as it does not have an amine group to start with. FIG. 15C displays a schematic showing an example of diazotization of the base resulting in base diazonium, which is the reactive species. FIG. 15. D displays a drawing with the chemical structure of example nucleotide bases. Amine group is highlighted with a red circle.

FIGS. 16A-16B. FIG. 17 displays a schematic showing the chemical structure of exemplary guanine defects. FIG. 17A display a schematic representation of covalently bonded guanine bases in DNA. FIG. 17B displays a schematic representation zoomed in at defect site showing the sp³ hybridization of defects.

FIGS. 17A-17B. FIG. 18 displays a schematic showing the chemical structure of exemplary cytosine defects. FIG. 18A displays a schematic representation of covalently bonded cytosine bases in DNA. FIG. 18B displays a schematic representation zoomed in at the defect site showing the sp³ hybridization of defects.

FIGS. 18A-18B. FIG. 19 displays a schematic showing the chemic structure of exemplary adenine defects. FIG. 19A displays a schematic representation of covalently bonded adenine bases in DNA. FIG. 19B displays a schematic representation zoomed in at the defect site showing the sp³ hybridization of defects.

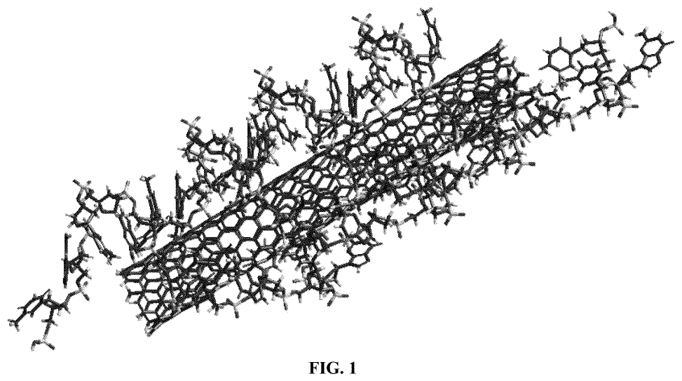

Particular non-limiting embodiments of the present invention will now be described with reference to accompanying drawings.

### DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

As used herein, the term “functionalized carbon nanotube composite biomaterial” refers to a material comprising a carbon nanotube and a biopolymer, wherein said biopolymer is directly (e.g., covalently) bonded to said carbon nanotube, forming one or more sp³ defects (i.e., organic color centers) on said carbon nanotube. The biomaterial exhibits shortwave infrared photoluminescence redshift by more than 10% in energy from the native photoluminescence of said carbon nanotube.

As used herein, the term “organic color center”, used interchangeably herein with the term “OCC”, refers to sp³ quantum defects that can be synthesized in pristine carbon nanotube semiconductor crystals using organic chemistry techniques. They are formed by sp³-hybridized atomic defects in the sp² carbon lattice of the nanotubes. Without wishing to be limited to any particular theory, these defects act as exciton traps, optically allowed to emit photoluminescence in the short-wave infrared range (900-2000 nm). The emission from OCCs is bright and can be tuned at the molecular level; it is also of a single-photon nature, making OCCs promising for efficient quantum interfaces.

As used herein, the term “sp³ defect”, with respect to carbon nanotubes, refers to points within the carbon nanotube lattice where the hybridization of carbon atoms changes from the typical sp² configuration to an sp³ configuration.

As used herein, the term “biopolymer” refers to natural polymers produced by or derived from living organisms. These include oligonucleotides (such as RNA or DNA, e.g., single-stranded DNA), proteins, and peptides. In some embodiments, oligonucleotides include one or more nitrogenous bases, e.g., guanine, adenine, or cytosine, and combinations thereof. In some embodiments, proteins or peptides may include at least one aromatic amino acid (e.g., from histidine, tyrosine, tryptophan, phenylalanine, or combinations thereof). In some embodiments, said biopolymer is halide free. In further embodiments, said biopolymer contains one or more amino (—NH₂) groups. The nitrogen of said amino (—NH₂) groups may be directly bonded to a conjugated moiety of said biopolymer.

As used herein, the term “native photoluminescence” refers to the photoluminescence of a carbon nanotube free of sp³ defects.

As used herein, the term “diazotization” refers to the chemical conversion of a primary amine group to a diazonium group.

As used herein, the term “single-stranded DNA” refers to a DNA molecule comprising a single continuous chain of nucleotides. This is opposed to the double-stranded double helix structure.

One aspect of the invention pertains to a functionalized carbon nanotube composite biomaterial, said composite biomaterial comprising:
a. a carbon nanotube; and
b. a biopolymer;
   wherein said biopolymer is directly (e.g., covalently) bonded to a surface of said carbon nanotube and forms one or more sp³ defects (i.e., organic color centers); and wherein said composite biomaterial exhibits shortwave infrared photoluminescence redshifted by more than 10% in energy from the native photoluminescence of said carbon nanotube.

Another aspect of the invention pertains to a method of making a functionalized carbon nanotube composite biomaterial, said method comprising:
a. providing a carbon nanotube and a biopolymer;
b. preparing a mixture of said carbon nanotube and said biopolymer; and
c. irradiating said mixture with UV light in the presence of an atmosphere comprising at least one gas to obtain said functionalized carbon nanotube composite biomaterial.

An additional aspect of the invention pertains to a method of making a functionalized carbon nanotube composite biomaterial, said method comprising:
a. providing a carbon nanotube and a biopolymer comprising at least one amino group;
b. preparing a mixture of said carbon nanotube and said biopolymer;
c. adjusting the pH of said mixture to be acidic; and
d. adding a nitrite salt to said mixture to obtain a functionalized carbon nanotube composite biomaterial.

A further aspect of the invention pertains to a functionalized carbon nanotube composite biomaterial, wherein said composite biomaterial is prepared by a method disclosed herein.

### 1.0 Functionalized Carbon Nanotube Composite Biomaterial

Embodiments of the present disclosure seek to address and transcend previously discussed shortcomings by pioneering a new class of DNA-SWCNT hybrids with sp³ defect traps. These sp³ defects not only emit at longer wavelengths but are also significantly brighter in photoluminescence, overcoming the shortcomings of sp² defects. This technological leap forward introduces materials with enhanced stability and distinctive functional optical properties, carving new avenues for high-precision sensing and quantum technologies. By systematically programming sp³ quantum defects with biopolymers such as DNA and harnessing photochemical processes for defect creation, a new realm of hybridized functional materials were engineered that could revolutionize nanotechnology and materials science. This approach provides an expansive design space to utilize a multitude of OCCs, SWCNT species, and DNA sequences (and the like) to assemble a wide array of nano sensor arrays.

In at least one aspect of the present disclosure, sp³ defect traps can be defined as lower energy states existing below conduction band of carbon nanotube arising as result of creating sp³ carbon centers in a sp² carbon lattice. The range of wavelength of a defect depends upon the type of defect. The wavelength will be red shifted greater than pristine carbon nanotube emission. sp³ defects have a higher quantum yield compared to pristine emission. The depth of a trap can be measured based on how red shifted the defect emission is with respect to pristine nanotube emission; the more redshifted the deeper the trap.

While existing methodologies utilizing guanine chemistry and visible light can facilitate interactions with DNA, they primarily lead to the creation of sp² defects. These sp² defects are characterized as shallow exciton traps. They tend to emit dim and broad photoluminescence, which significantly limits their applicability, especially in fields where precision and clarity are paramount.

Embodiments of the present disclosure overcome these shortcomings by pioneering a new class of DNA-SWCNT hybrid materials distinguished by bright defect color centers. The sp³ defect traps introduced through our process are considerably deeper than the sp² counterparts. This larger potential well depth translates to emission at longer wavelengths, which not only enhances the brightness of the photoluminescence but also markedly improves the stability of the nanomaterials.

Moreover, the intersection of organic color centers (OCCs), various carbon nanotube (CNT) species and a myriad of DNA sequences constitutes a robust and versatile design space for creating nanosensor arrays. This inventive combination harnesses the potential to generate an extensive array of distinct sensors. By marrying different OCCs with diverse SWCNT chiralities and DNA sequences, embodiments of the present disclosure provide an unprecedented range of tunability and specificity in sensor design and function.

Furthermore, our technique of programming sp³ quantum defects along the SWCNTs, facilitated by DNA sequences and activated via photochemical processes, results in a striking photoluminescence that significantly shifts away from the nanotube's native emission spectrum. This shift is not merely incremental; it represents a transformative improvement that redefines the capabilities of hybridized functional materials. The enhanced brightness and spectral shift indicate a significant stride in developing materials poised to revolutionize sensing technology and quantum applications.

### 2.0. Functionalized Carbon Nanotube Composite Biomaterial Fabricated Via Diazotization

Aryl diazonium salts covalently bond with SWCNTs to form aryl sp³ defect-induced OCCs which result in enhanced photoluminescence. These sp³ defect centers effectively brighten previously dark excitons and significantly increase the quantum yield of SWCNTs.

DNA is well-known for its ability to wrap around SWCNTs. Recent advancements have demonstrated a singlet oxygen-mediated covalent conjugation of guanine nucleotide bases to SWCNTs, as reported by Zheng and Lin. However, this guanine-based chemistry introduces sp² defects, instead of sp³ defects, with shallow exciton traps that limit their efficacy in applications such as quantum sensing and quantum light sources.

Iodine-based photochemical methods to covalently link biopolymers, such as DNA, to single-walled carbon nanotubes (SWCNTs) by incorporating photosensitive modified RNA bases, such as 5-iodo-2′-deoxyuridine (5-I-dU), rendering the DNA photolabile is well known. See e.g., U.S. Pat. No. 9,983,058 and U.S. Ser. No. 10/414,974. However, fabricating using halogenated approach requires pre-treatment of the biopolymer (such as DNA) to make a halogenated biopolymer prior to attachment to the carbon nanotube presents several limitations, Notably, the resulting organic color centers (OCCs) are restricted to bonding through the halogenated sites, leading to OCCs that are structurally and functionally distinct from those produced by the methods disclosed herein—namely in situ diazotization or the UV (under inert environment). Furthermore, the halogenated bond formation necessitates the use of modified bases and limits the applicability of halogenated fabrication approach involving halogenation of the hiopolymer prior to formation to attachment to carbon nanotube (see U.S. Pat. No. 10,414,974) to only specific nucleotides.

One advantage of methods disclosed herein is that does not require modified bases, thereby maintaining stability of the biopolymer, which broadens applicability of the methods disclosed herein to a wider range of natural and engineered biopolymers. This significantly reduces manufacturing costs.

One aspect of the invention pertains to a novel biopolymer-single-walled carbon nanotube (SWCNT) composite material is herein disclosed, wherein biopolymers, such as DNA, are covalently bonded to SWCNTs through in situ diazotization activation of amino (—NH₂)-bearing bases. DNA comprises four nitrogenous bases-adenine (A), guanine (G), cytosine (C), and thymine (T) with thymine being the sole base lacking an amino group (—NH₂). In one embodiment, the amine groups present in adenine, guanine, and cytosine are activated via in situ diazotization under acidic conditions in the presence of sodium nitrite (NaNO₂). This activation facilitates the direct bonding of these specific bases to the SWCNTs, thereby enabling the synthesis of A-, G-, and C-tailored organic color centers (OCCs). Consequently, DNA is covalently attached to the SWCNT sidewalls through the amino sites rather than halogenated sites, resulting in a distinctly different composite material characterized by sp³ defect-induced OCCs.

While the demonstrated examples utilize DNA containing guanine (G), adenine (A), and cytosine (C) bases, the methodology is extensible to other biomolecules, including RNA, peptides, and synthetic biopolymers that possess primary amine functional groups connected to conjugated aromatic moieties. A diverse range of composite materials may then be used without the necessity for modified bases, enhancing the applicability and scalability.

Examples of biopolymers or bases which would not be applicable include the following. Bases thymine and uracil lack amino groups connected to conjugated systems, while polyamines, polylysines, and chitosans are not connected to conjugated aromatic systems, despite containing amino groups.

Integrating SWCNTs with DNA, a biocompatible and highly specific polymer, significantly enhances the applicability of these composites in biological environments. The inherent specificity of DNA binding and its ability to interact with a broad spectrum of biomolecules render these hybrids powerful tools for biosensing and imaging applications, where precise molecular recognition is desired.

### LIST OF EMBODIMENTS

1. A functionalized carbon nanotube composite biomaterial, said composite biomaterial comprising:
   a. a carbon nanotube; and
   b. a biopolymer;
   wherein said biopolymer is directly bound via a covalent bond to a surface of said carbon nanotube and forms one or more sp³ defects (i.e., organic color centers (OCCs)); and wherein said composite biomaterial exhibits shortwave infrared photoluminescence redshift by more than about 10% (more than about 20%, about 30%, about 40%, about 50%, about 60%, about 70%, about 80%, or about 90%, or about 10-90%, about 10-50%, or about 50 to 90%) in energy from the native photoluminescence of said carbon nanotube.
2. The composite biomaterial of claim 1, wherein said carbon nanotube is a semiconducting carbon nanotube.
3. The composite biomaterial of any of the preceding embodiments, wherein said carbon nanotube is a single-walled carbon nanotube (SWCNT).
4. The composite biomaterial of any of the preceding embodiments, wherein said carbon nanotube has a chirality, wherein said chirality is chosen from (6,4), (6,5), (8,3), (9,1), (9,2), (7,5), (7,6), (8,7), (10,5), or (11,3), and combinations thereof.
5. The composite biomaterial of any of the preceding embodiments, wherein said carbon nanotube has a diameter is the range from about 0.6 nm to about 1.1 nm (e.g., from about 0.65 nm to about 0.9 nm).
6. The composite biomaterial of any of the preceding embodiments, wherein said biopolymer comprises an oligonucleotide.
7. The composite biomaterial of any of the preceding embodiments, wherein said oligonucleotide comprises one or more nitrogenous bases.
8. The composite biomaterial of any of the preceding embodiments, wherein said nitrogenous bases are chosen from guanine, adenine, or cytosine, and combinations thereof.
9. The composite biomaterial of any of the preceding embodiments, wherein said oligonucleotide comprises RNA or DNA.
10. The composite biomaterial of any of the preceding embodiments, wherein said DNA is single-stranded DNA (ssDNA).
11. The composite biomaterial of any of the preceding embodiments, wherein said biopolymer comprises proteins or peptides.
12. The composite biomaterial of any of the preceding embodiments, wherein said proteins or peptides comprise at least one aromatic amino acid.
13. The composite biomaterial of any of the preceding embodiments, wherein said at least one aromatic amino acid is chosen from histidine, tyrosine, tryptophan, phenylalanine, or combinations thereof.
14. The composite biomaterial of any of the preceding embodiments, wherein said one or more sp³ defects are uniformly distributed along the length of said carbon nanotube.
15. The composite biomaterial of any of the preceding embodiments, wherein said one or more sp³ defects are functionalized with metallic nanoparticles using known methods.
16. The composite biomaterial of any of the preceding embodiments, wherein said carbon nanotube has a native photoluminescence, and wherein said one or more sp³ defects have shortwave infrared photoluminescence.
17. The composite biomaterial of any of the preceding embodiments, wherein said shortwave infrared photoluminescence of said one or more sp³ defects has a redshifted emission.
18. The composite biomaterial of any of the preceding embodiments, wherein said shortwave infrared photoluminescence of said one or more sp³ defects is redshifted from said native photoluminescence of said carbon nanotubes by at least 10%.
19. The composite biomaterial of any of the preceding embodiments, wherein said redshifted emission is in the range of about 900 nm to about 2000 nm (e.g., about 950 nm to about 1600 nm).
20. The composite biomaterial of any of the preceding embodiments, wherein said shortwave infrared photoluminescence has a spectral bandwidth of about 100 nm.
21. The composite biomaterial of any of the preceding embodiments, wherein said composite material is encapsulated within a biocompatible polymer using known methods.
22. The composite biomaterial of any of the preceding embodiments, wherein said DNA is functionalized with a fluorescent dye using known methods.
23. The composite biomaterial of any of the preceding embodiments, wherein said biopolymer is halide free.
24. The composite biomaterial of any of the preceding embodiments, wherein said biopolymer comprises one or more amino (—NH₂) groups.
25. The composite biomaterial of any of the preceding embodiments, wherein the nitrogen atom of said one or more amino groups is directly bonded to a conjugated moiety of said biopolymer.
26. A method of making a functionalized carbon nanotube composite biomaterial, said method comprising:
   a. providing a carbon nanotube and a halide-free biopolymer;
   b. preparing a mixture of said carbon nanotube and said biopolymer; and
   c. irradiating said mixture with UV light in the presence of an atmosphere comprising at least one gas to obtain said functionalized carbon nanotube composite biomaterial.
27. The method of any of the preceding embodiments, wherein said irradiating covalently binds said biopolymer to said carbon nanotube and causes the formation of sp³ defects on said carbon nanotube.
28. The method of any of the preceding embodiments, wherein said at least one gas in said atmosphere is chosen from nitrogen and argon, or combinations thereof.
29. The method of any of the preceding embodiments, wherein preparing said mixture comprises mechanical sonication, and wherein said mechanical sonication occurs at a frequency and at a duration.
30. The method of any of the preceding embodiments, wherein said frequency and said duration are sufficient to disperse said carbon nanotubes within said mixture.
31. The method of any of the preceding embodiments, wherein said UV light has a wavelength in the range of about 200 nm to about 400 nm (e.g., in the range of about 240 nm to about 280 nm).
32. The method of any of the preceding embodiments, wherein said UV light has a wavelength of about 254 nm.
33. The method of any of the preceding embodiments, wherein said UV light has an intensity in the range of about 0.5 mW/cm² to about 5 mW/cm².
34. The method of any of the preceding embodiments, wherein said method further comprises washing said mixture with a solvent following irradiation, wherein said washing removes unbound biopolymers.
35. The method of any of the preceding embodiments, wherein said atmosphere has a pressure in the range of about 1 atm to about 5 atm.
36. A method of making a functionalized carbon nanotube composite biomaterial, said method comprising:
   a. providing a carbon nanotube and a biopolymer comprising at least one amino group;
   b. preparing a mixture of said carbon nanotube and said biopolymer;
   c. adjusting the pH of said mixture to be acidic; and
   d. adding a nitrite salt to said mixture to obtain a functionalized carbon nanotube composite biomaterial.
37. The method of any of the preceding embodiments, wherein the pH of said mixture is in the range of about 1 to about 6 (e.g., about 2 to about 4).
38. The method of any of the preceding embodiments, wherein said mixture comprises a phosphate-buffered saline (PBS) solution.
39. The method of any of the preceding embodiments, wherein said diazotization covalently binds said biopolymer to said carbon nanotube and causes the formation of sp³ defects on said carbon nanotube.
40. The method of any of the preceding embodiments, wherein said at least one amino group is attached to a conjugated aromatic system of said biopolymer.
41. The method of any of the preceding embodiments, wherein said nitrite salt is chosen from sodium nitrite, lithium nitrite, or potassium nitrite, and combinations thereof.
42. The method of any of the preceding embodiments, wherein said biopolymer is an oligonucleotide.
43. The method of any of the preceding embodiments, wherein said oligonucleotide comprises one or more nitrogenous bases.
44. The composite material of any of the preceding embodiments, wherein said nitrogenous bases are chosen from guanine, adenine, or cytosine, and combinations thereof.
45. The method of any of the preceding embodiments, wherein said biopolymers is chosen from RNA, DNA, protein, peptides, synthetic biopolymers, and combinations thereof.
46. The method of any of the preceding embodiments, wherein said synthetic biopolymers are amino-terminated polystyrene derivatives.
47. The method of any of the preceding embodiments, wherein said protein or said peptides comprise at least one aromatic amino acid.
48. The method of any of the preceding embodiments, wherein said at least one aromatic amino acid is chosen from histidine, tryptophan, tyrosine, or phenylalanine, and combinations thereof.
49. A functionalized carbon nanotube composite biomaterial of any of the preceding embodiments, wherein said biomaterial is prepared by a method of any of the preceding embodiments.

### EXAMPLES

The following examples are provided solely to illustrate the present invention and are not intended to limit the scope of the invention, described herein. All publications mentioned herein are incorporated by reference to the extent they support the present invention.

### Example 1. Materials and Experimental Procedures for Dispersion

A DNA sequence with the bases ′5-TGTGTGTGTGTGT-3′ was prepared by dissolving it in deuterium oxide (or water) consisting of 0.1 M NaCl and 2 mM NaHCO₃. To 800 μL of this solution was added 0.2 mg of CoMoCat SG65i. The mixture was then subjected to tip sonication for 15 minutes at 4 watts of power, alternating with pulses of 10 seconds on and 6 seconds off.

Following this step, 0.2 mg (or 200 μL) of the previously prepared DNA solution was incorporated into the sonicated single-wall carbon nanotube (SWCNT) solution. The combination was then further sonicated for 30 minutes under the same conditions to ensure thorough dispersion.

Following sonication, the mixture was centrifuged at 24,000 g for one hour to remove aggregated bundles. The supernatant was collected and diluted in a fresh solution of 0.1 M NaCl and 2 mM Na₂CO₃, adjusted to an approximate pH of 9. This final solution was used for subsequent experiments.

### Example 2. UV Irradiation of T(GT)6-Dispersed SG65i

For UV irradiation experiments, a concentrated dispersion of SG65i with T(GT)6 DNA, as prepared from the procedures outlined in the previous section, was utilized. This dispersion was in a NaCl—Na₂CO₃-D₂O solution and adjusted to achieve a final optical density (OD) of 0.13 at 994 nm, which corresponds to the E11 transition of the (6,5)-SWCNT. The solution also contained 2 mM Na₂CO₃ at a pH of approximately 9, and 0.1 M NaCl in D₂O.

A 1 mL aliquot of the dispersion was placed into a quartz cuvette that contained a magnetic bead for stirring. The cuvette was then exposed to 254 nm UV light from a UV lamp. During this irradiation, continuous stirring was maintained.

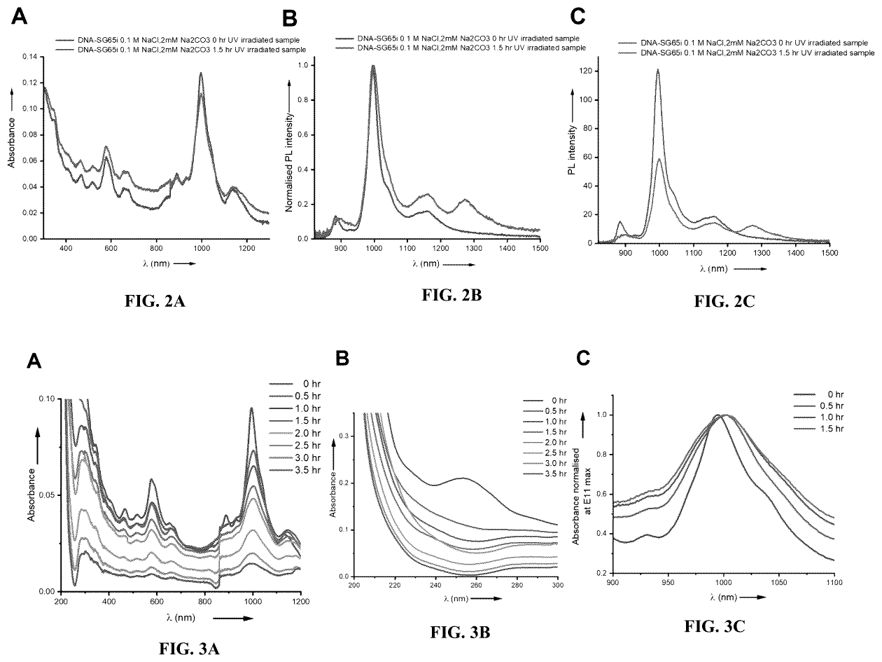

Both the absorption and emission spectra of the sample were monitored to observe the progress of the reaction. The reaction resulted in the quenching of fluorescence and the emergence of a new, albeit not very prominent, peak at 1290 nm. The spectral details and changes are presented in FIG. 2.

### Example 3. Monitoring of UV Reaction Kinetics by Absorption Spectroscopy

To study the kinetics of the UV-induced reaction, an SG65i-DNA solution with an optical density (OD) of 0.1 was prepared. This solution was adjusted to a final concentration of 0.1 M NaCl and 2.5 mM Na₂CO₃ to achieve a pH of approximately 9, slightly higher than in previous experiments to stabilize the pH at 9.

A 1.5 mL aliquot of the prepared solution was placed into a quartz cuvette, which contained a magnetic bead for stirring. The cuvette was subjected to 254 nm UV radiation from a UV lamp positioned closer to the cuvette than in previous setups to enhance the intensity of exposure. Throughout the process, the solution was continuously stirred.

The absorption spectrum of the solution was recorded at 30-minute intervals. During these intervals, specific attention was given to the changes in the E11 peak at 994 nm, which is characteristic of the (6,5)-SWCNT, and the DNA-specific absorption at 260 nm. These measurements aimed to elucidate the kinetics of the reaction between the DNA and the nanotubes under UV irradiation.

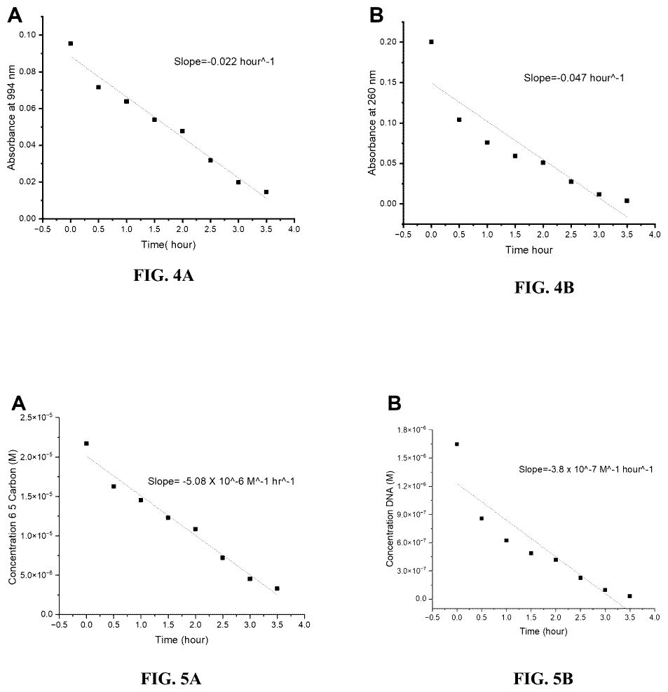

The results of this kinetic study are summarized in FIGS. 3-5.

### Example 4. UV Irradiation of T(GT)6 Dispersed SG65i in a Nitrogen Atmosphere

A concentrated solution of SG65i SWCNTs dispersed with T(GT)6 DNA was prepared in a solution containing NaCl and Na₂CO₃ in D₂O. The solution was formulated to achieve an optical density (OD) of 0.14 at 994 nm, corresponding to the E11 transition of (6,5)-SWCNT, with the pH maintained approximately at 9 using 2 mM Na₂CO₃ and a NaCl concentration of 0.1 M.

For the irradiation experiment, 1 mL of this concentrated dispersion was transferred into a quartz cuvette, which was then sealed with parafilm. To create an inert atmosphere, nitrogen gas was bubbled through the solution for 2 minutes without any UV exposure. Following this, the solution continued to be purged with nitrogen gas, but now simultaneously irradiated with 254 nm UV light from a lamp positioned close to the cuvette for a period of 20 minutes, all the while ensuring continuous stirring of the mixture.

After the irradiation process was completed, the mixture was further purged with nitrogen for an additional 2 minutes in the absence of UV light to ensure the removal of any residual reactive species before the seal was opened.

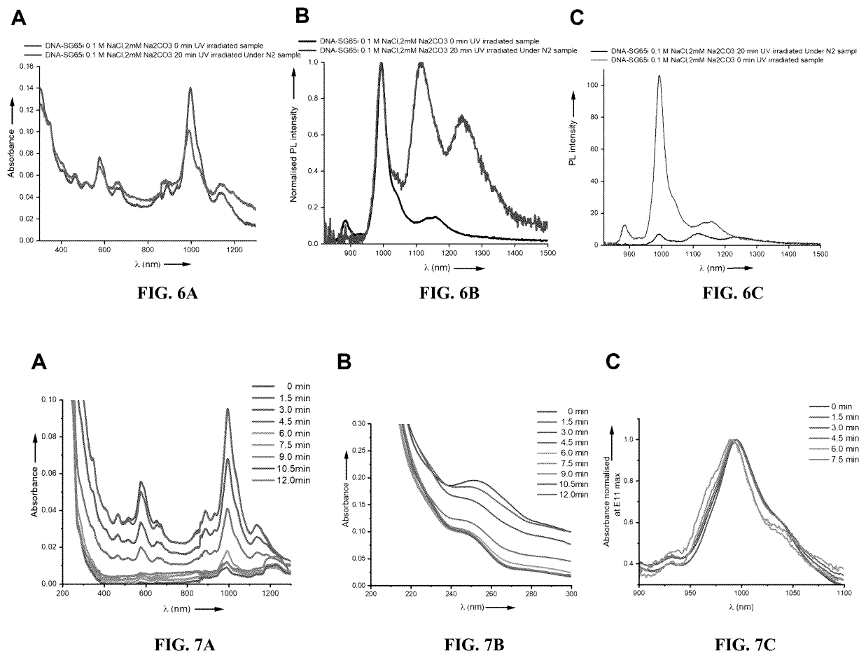

The absorption of the same and the emission properties were closely monitored to observe the progression of the reaction. A notable quenching of fluorescence was observed, alongside the emergence of new peaks at 1117 nm and 1239 nm, indicative of changes within the nanotube structure. The detailed spectral data following these changes are presented in FIG. 6.

### Example 5. Monitoring the Kinetics of UV Reaction Under Nitrogen Purging by Absorption Spectroscopy

The SG65i-DNA solution, with an optical density of 0.1, was reconstituted according to the previous protocol. The ionic strength and the buffering capacity of the solution were adjusted to a final concentration of 0.1 M NaCl and 2.5 mM Na₂CO₃ to achieve a stable pH of approximately 9, slightly higher than before, to fine-tune the pH balance.

For the experimental setup, 1.5 mL of the prepared solution was placed into a quartz cuvette, which was then sealed on top with parafilm to create a controlled environment. Nitrogen gas was flushed through the solution for 2 minutes without UV exposure to establish an inert atmosphere, followed by a combined nitrogen purge and UV irradiation from a closely positioned UV lamp emitting at 254 nm for a duration of 1.5 minutes, ensuring constant stirring to promote uniform exposure. This pre-irradiation and irradiation purging cycle was carried out several times, extending the total UV exposure time to 12 minutes.

Following each irradiation session, the cuvette was purged again with nitrogen gas for an additional 2 minutes without UV exposure to remove any oxygen or other reactive entities before the parafilm seal was removed for spectrum analysis.

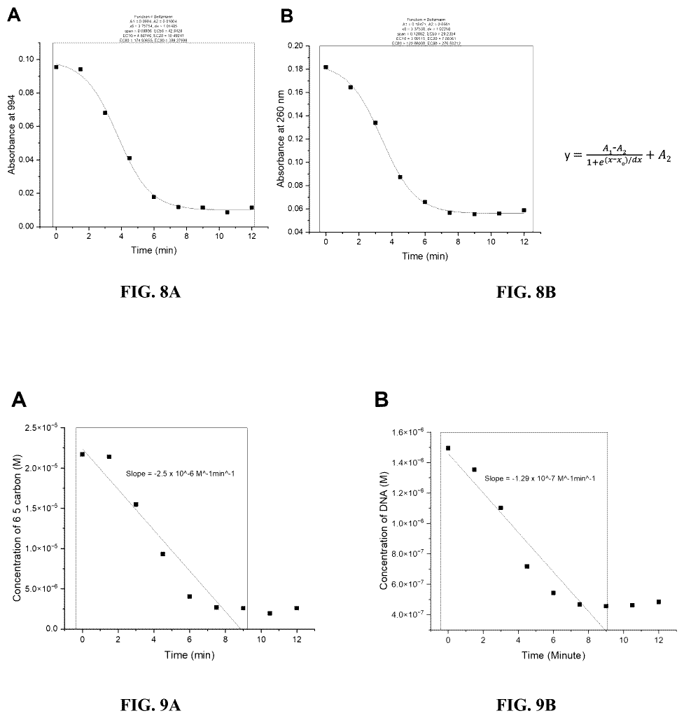

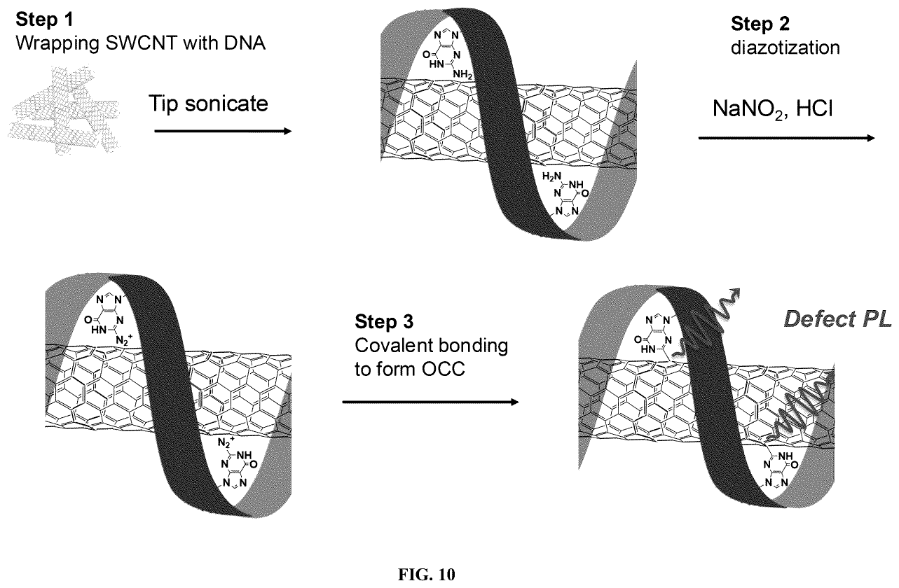

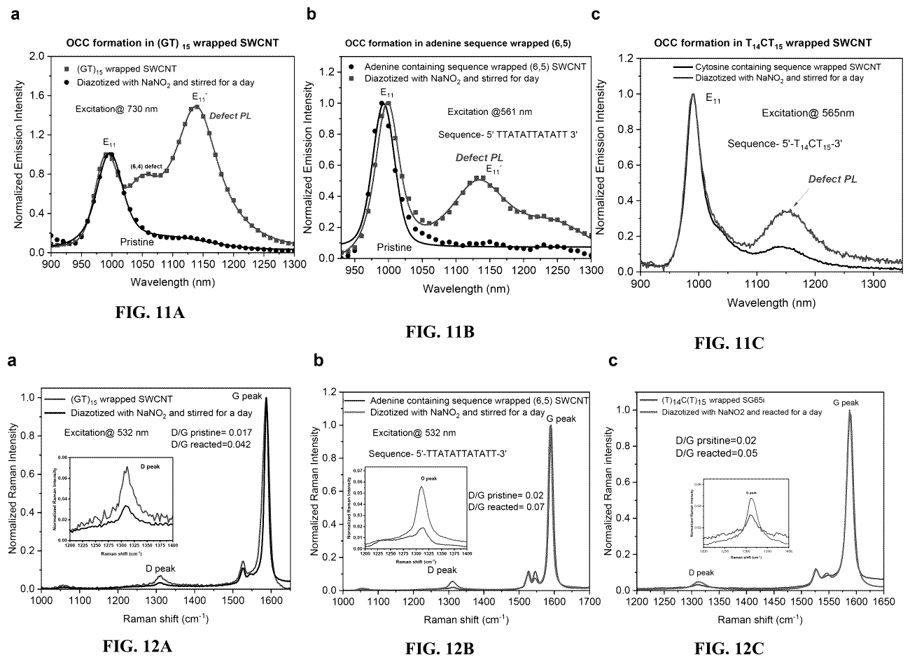

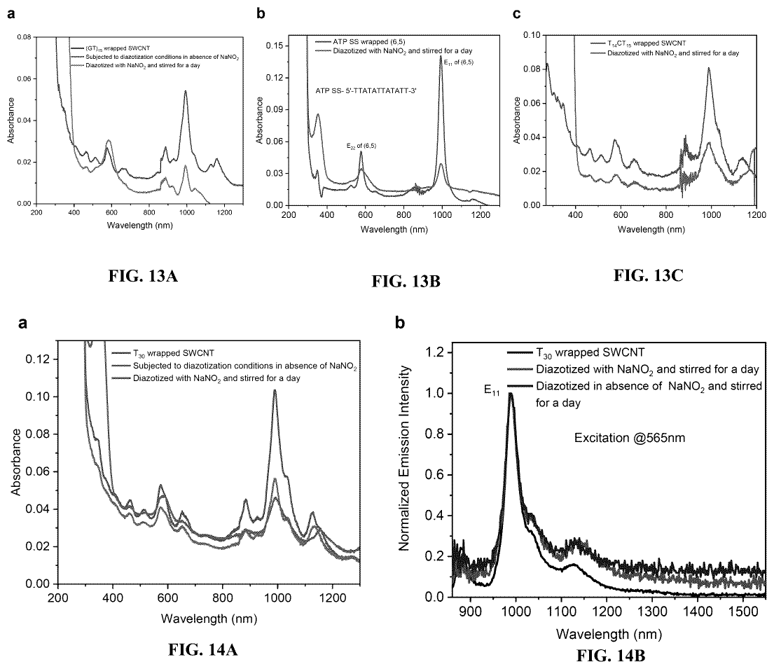

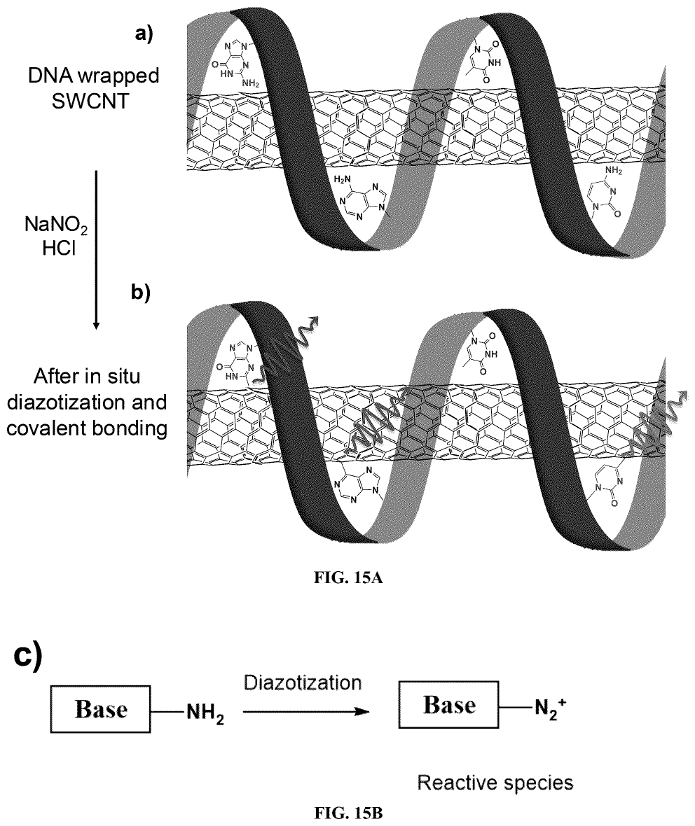

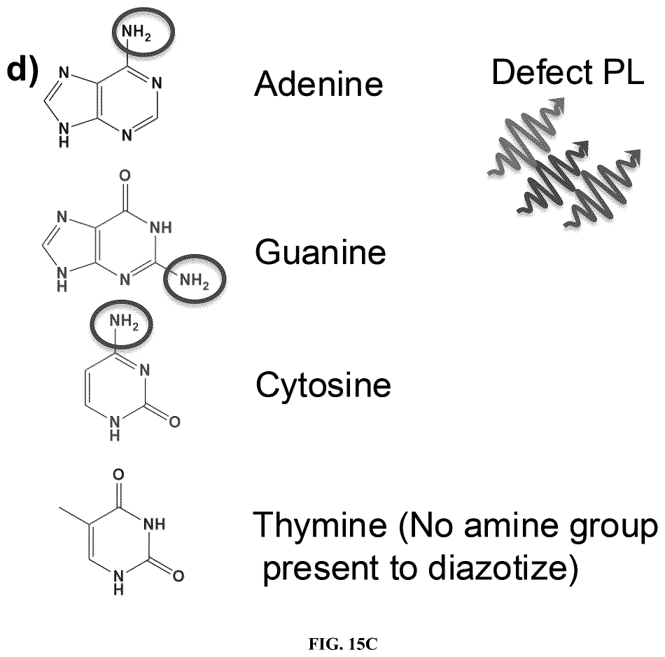

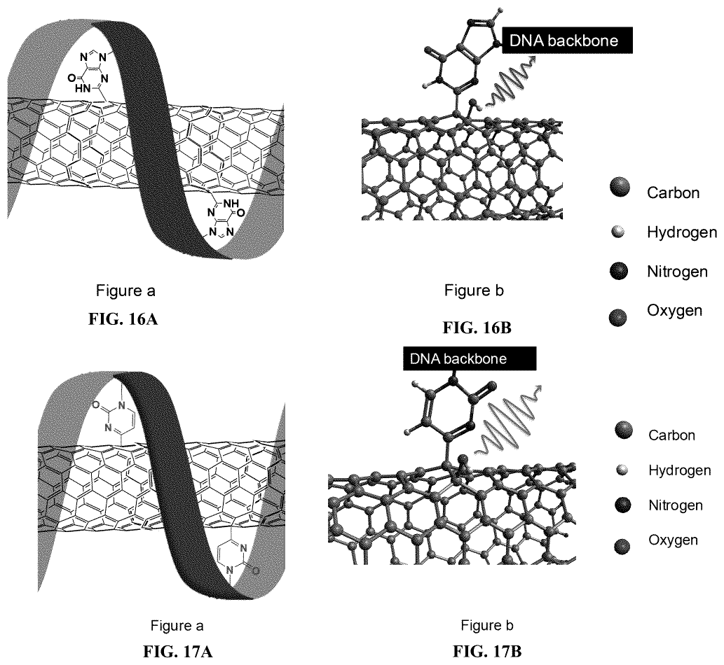

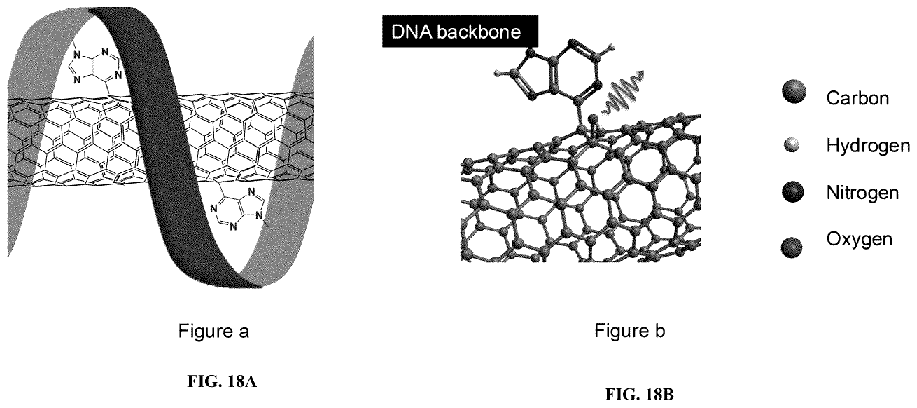

The absorption spectrum of the sample was recorded at 30-minute intervals. The changes in the E11 peak at 994 nm and the DNA-specific absorption at 260 nm were monitored to reveal the kinetics of the reaction between the DNA and the SG65i SWCNTs under the modified conditions of nitrogen atmosphere and intensified UV irradiation. The results are summarized in FIGS. 7-9.

### Example 6. Diazotization Process

An exemplary in situ diazotization synthesis process may involve the following steps:

Dispersion: Single-stranded DNA or RNA containing amino (—NH₂)-bearing bases is dissolved in a phosphate-buffered saline (PBS) solution. SWCNTs are then introduced into this solution and uniformly dispersed through tip ultrasonication.

Covalent Functionalization: Under controlled acidic conditions and in the presence of sodium nitrite (NaNO₂), the amino groups in the nucleobases undergo diazotization. This reaction transforms the amino groups into diazonium intermediates, which subsequently form stable covalent bonds with the SWCNT sidewalls, creating sp³ defect-induced OCCs.

Characterization: The diazotization process and subsequent covalent bonding are monitored using absorption spectroscopy, photoluminescence spectroscopy, and Raman spectroscopy. These techniques confirm the formation of sp³ defects and the associated modifications in the electronic and optical properties of the SWCNTs.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
[1] Miyauchi, Y. Photoluminescence studies on exciton photophysics in carbon nanotubes. Journal of Materials Chemistry C 2013, 1 (40), 6499-6521. DOI: 10.1039/c3tc00947e.
[2] Welsher, K.; Liu, Z.; Sherlock, S. P.; Robinson, J. T.; Chen, Z.; Daranciang, D.; Dai, H. J. A route to brightly fluorescent carbon nanotubes for near-infrared imaging in mice. Nature Nanotechnology 2009, 4 (11), 773-780. DOI: 10.1038/nnano.2009.294.
[3] Gao, F. W.; Xu, H. L.; Su, Z. M. Tuning Second-Order Nonlinear Optical Properties of Cross-Linked Carbon Nanotube via External Electric Field. Journal of Physical Chemistry C 2020, 124 (6), 3778-3783. DOI: 10.1021/acs.jpcc.9b10759.
[4] Kim, M.; Chen, C.; Wang, P.; Mulvey, J. J.; Yang, Y.; Wun, C.; Antman-Passig, M.; Luo, H. B.; Cho, S.; Long-Roche, K.; et al. Detection of ovarian cancer via the spectral fingerprinting of quantum-defect-modified carbon nanotubes in serum by machine learning. Nature Biomedical Engineering 2022, 6 (3), 267-+. DOI: 10.1038/s41551-022-00860-y.
[5] Piao, Y.; Meany, B.; Powell, L. R.; Valley, N.; Kwon, H.; Schatz, G. C.; Wang, Y. Brightening of carbon nanotube photoluminescence through the incorporation of sp3 defects. Nat. Chem. 2013, 5 (10), 840-845. DOI: 10.1038/nchem.1711.
[6] Brozena, A. H.; Kim, M.; Powell, L. R.; Wang, Y. Controlling the optical properties of carbon nanotubes with organic colour-centre quantum defects. Nature Reviews Chemistry 2019, 3 (6), 375-392. DOI: 10.1038/s41570-019-0103-5.
[7] Kwon, H.; Furmanchuk, M.; Kim, M.; Meany, B.; Guo, Y.; Schatz, G. C.; Wang, Y. H. Molecularly Tunable Fluorescent Quantum Defects. Journal of the American Chemical Society 2016, 138 (21), 6878-6885. DOI: 10.1021/jacs.6b03618.
[8] Brozena, A. H.; Leeds, J. D.; Zhang, Y.; Fourkas, J. T.; Wang, Y. H. Controlled Defects in Semiconducting Carbon Nanotubes Promote Efficient Generation and Luminescence of Trions. Acs Nano 2014, 8 (5), 4239-4247. DOI: 10.1021/nn500894p.
[9] Kwon, H.; Kim, M.; Nutz, M.; Hartmann, N. F.; Perrin, V.; Meany, B.; Hofmann, M. S.; Clark, C. W.; Htoon, H.; Doom, S. K.; et al. Probing Trions at Chemically Tailored Trapping Defects. Acs Central Science 2019, 5 (11), 1786-1794. DOI: 10.1021/acscentsci.9b00707.
[10] Chen, J. S.; Trerayapiwat, K. J.; Sun, L.; Krzyaniak, M. D.; Wasielewski, M. R.; Rajh, T.; Sharifzadeh, S.; Ma, X. D. Long-lived electronic spin qubits in single-walled carbon nanotubes. Nature Communications 2023, 14 (1). DOI: 10.1038/s41467-023-36031-z.
[11] Shiraishi, T.; Shiraki, T.; Nakashima, N. Substituent effects on the redox states of locally functionalized single-walled carbon nanotubes revealed by <i>in situ</i> photoluminescence spectroelectrochemistry. Nanoscale 2017, 9 (43), 16900-16907. DOI: 10.1039/c7nr05480g.
[12] Shiraki, T.; Niidome, Y.; Toshimitsu, F.; Shiraishi, T.; Shiga, T.; Yu, B. D.; Fujigaya, T. Solvatochromism of near infrared photoluminescence from doped sites of locally functionalized single-walled carbon nanotubes. Chemical Communications 2019, 55 (25), 3662-3665. DOI: 10.1039/c9cc00829b.
[13] Zheng, M.; Jagota, A.; Semke, E. D.; Diner, B. A.; McLean, R. S.; Lustig, S. R.; Richardson, R. E.; Tassi, N. G. DNA-assisted dispersion and separation of carbon nanotubes. Nature Materials 2003, 2 (5), 338-342. DOI: 10.1038/nmat877.
[14] Powell, L. R.; Piao, Y. M.; Ng, A. L.; Wang, Y. H. Channeling Excitons to Emissive Defect Sites in Carbon Nanotube Semiconductors beyond the Dilute Regime. Journal of Physical Chemistry Letters 2018, 9 (11), 2803-2807. DOI: 10.1021/acs.jpclett.8b00930.
[15] Spreinat, A.; Dohmen, M. M.; Lüttgens, J.; Herrmann, N.; Klepzig, L. F.; Nissler, R.; Weber, S.; Mann, F. A.; Lauth, J.; Kruss, S. Quantum Defects in Fluorescent Carbon Nanotubes for Sensing and Mechanistic Studies. Journal of Physical Chemistry C 2021, 125 (33), 18341-18351. DOI: 10.1021/acs.jpcc.1c05432.
[16] Kwon, H.; Kim, M.; Meany, B.; Piao, Y. M.; Powell, L. R.; Wang, Y. H. Optical Probing of Local pH and Temperature in Complex Fluids with Covalently Functionalized, Semiconducting Carbon Nanotubes. Journal of Physical Chemistry C 2015, 119 (7), 3733-3739. DOI: 10.1021/jp509546d.
[17] Zheng, Y.; Alizadehmojarad, A. A.; Bachilo, S. M.; Weisman, R. B. Guanine-Specific Chemical Reaction Reveals ssDNA Interactions on Carbon Nanotube Surfaces. Journal of Physical Chemistry Letters 2022, 13 (9), 2231-2236. DOI: 10.1021/acs.jpclett.2c00030.
[18] Zheng, Y.; Kim, Y.; Jones, A. C.; Olinger, G.; Bittner, E. R.; Bachilo, S. M.; Doom, S. K.; Weisman, R. B.; Piryatinski, A.; Htoon, H. Quantum Light Emission from Coupled Defect States in DNA-Functionalized Carbon Nanotubes. Acs Nano 2021, 15 (6), 10406-10414. DOI: 10.1021/acsnano.lc02709.
[19] Lin, Z. W.; Beltran, L. C.; De los Santos, Z. A.; Li, Y. N.; Adel, T.; Fagan, J. A.; Walker, A. R. H.; Egelman, E. H.; Zheng, M. DNA-guided lattice remodeling of carbon nanotubes. Science 2022, 377 (6605), 535-+. DOI: 10.1126/science.abo4628.
[20] Metternich, J. T.; Wartmann, J. A. C.; Sistemich, L.; Nissler, R.; Herbertz, S.; Kruss, S. Near-Infrared Fluorescent Biosensors Based on Covalent DNA Anchors. Journal of the American Chemical Society 2023, 145 (27), 14776-14783. DOI: 10.1021/jacs.3c03336.
[21] Ng, A. L.; Chen, C. F.; Kwon, H.; Peng, Z. W.; Lee, C. S.; Wang, Y. H. Chemical Gating of a Synthetic Tube-in-a-Tube Semiconductor. Journal of the American Chemical Society 2017, 139 (8), 3045-3051. DOI: 10.1021/jacs.6b12111.
[22] Ackermann, J.; Metternich, J. T.; Herbertz, S.; Kruss, S. Biosensing with Fluorescent Carbon Nanotubes. Angewandte Chemie-International Edition 2022, 61 (18). DOI: 10.1002/anie.202112372.
[23] Mann, F. A.; Herrmann, N.; Opazo, F.; Kruss, S. Quantum Defects as a Toolbox for the Covalent Functionalization of Carbon Nanotubes with Peptides and Proteins. Angewandte Chemie-International Edition 2020, 59 (40), 17732-17738. DOI: 10.1002/anie.202003825.
[24] Wang, Y.; Wu, X.; Kwon, H.; Kim, M. Chemically coded quantum emitters and photochemical methods of creating same. USA US20180265779A1, 2019.

1. A functionalized carbon nanotube composite biomaterial, said composite biomaterial comprising:
a. a carbon nanotube; and
b. a biopolymer;
wherein said biopolymer is covalently bonded to a surface of said carbon nanotube and forms one or more sp³ defects;
and wherein said composite biomaterial exhibits shortwave infrared photoluminescence redshift by more than about 10% in energy from the native photoluminescence of said carbon nanotube.

2. The composite material of claim 1, wherein said carbon nanotube is a single-walled carbon nanotube.

3. The composite material of claim 1, wherein said biopolymer comprises an oligonucleotide.

4. The composite material of claim 3, wherein said oligonucleotide comprises one or more nitrogenous bases.

5. The composite material of claim 4, wherein said nitrogenous bases are chosen from guanine, adenine, or cytosine, and combinations thereof.

6. The composite material of claim 3, wherein said oligonucleotide comprises RNA or DNA.

7. The composite material of claim 1, wherein said redshifted emission is in the range of about 900 nm to about 2000 nm.

8. A method of making a functionalized carbon nanotube composite biomaterial, said method comprising:
a. providing a carbon nanotube and a halide-free biopolymer;
b. preparing a mixture of said carbon nanotube and said biopolymer; and
c. irradiating said mixture with UV light in the presence of an atmosphere comprising at least one gas to obtain said functionalized carbon nanotube composite biomaterial.

9. The method of claim 8, wherein said irradiating covalently binds said biopolymer to said carbon nanotube and causes the formation of sp³ defects on said carbon nanotube.

10. The method of claim 8, wherein said at least one gas in said atmosphere is chosen from nitrogen and argon, or combinations thereof.

11. The method of claim 8, wherein said UV light has a wavelength in the range of about 200 nm to about 400 nm.

12. The method of claim 8, wherein said UV light has an intensity in the range of about 0.5 mW/cm² to about 5 mW/cm².

13. A method of making a functionalized carbon nanotube composite biomaterial, said method comprising:
a. providing a carbon nanotube and a biopolymer comprising at least one amino group;
b. preparing a mixture of said carbon nanotube and said biopolymer;
c. adjusting the pH of said mixture to be acidic; and
d. adding a nitrite salt to said mixture to obtain a functionalized carbon nanotube composite biomaterial.

14. The method of claim 13, wherein said method covalently binds said biopolymer to said carbon nanotube and causes the formation of sp³ defects on said carbon nanotube.

15. The method of claim 13, wherein the pH of said mixture is in the range of about 1 to about 6.

16. The method of claim 13, wherein said at least one amino group is attached to a conjugated aromatic system of said biopolymer.

17. The method of claim 13, wherein said nitrite salt is chosen from sodium nitrite, lithium nitrite, or potassium nitrite, and combinations thereof.

18. The method of claim 13, wherein said biopolymer is an oligonucleotide.

19. The method of claim 13, wherein said biopolymer is chosen from RNA, DNA, protein, peptides, synthetic biopolymers, and combinations thereof.
